(19) United States
(12) Patent Application Publication
(10) Pub. No.: US 2025/0242805 A1
(43) Pub. Date: Jul. 31, 2025

(54) SYSTEM AND METHOD FOR PROVIDING DRIVER ASSISTANCE FEATURES

(71) Applicant: Toyota Jidosha Kabushiki Kaisha, Toyota-shi (JP)

(72) Inventor: Jaime S. Camhi Espinoza, Los Gatos, CA (US)

(73) Assignee: Toyota Jidosha Kabushiki Kaisha, Toyota-shi (JP)

(21) Appl. No.: 18/424,293

(22) Filed: Jan. 26, 2024

(51) Int. Cl. B60W 30/12; B60W 10/20; B60W 30/09; B60W 30/14

(52) U.S. Cl. CPC B60W 30/12; B60W 10/20; B60W 30/09; B60W 30/143; B60W 2420/24; B60W 2420/403; B60W 2510/202; B60W 2540/10; B60W 2540/12; B60W 2540/223

(57) ABSTRACT

A vehicle system of a vehicle may comprise one or more processors configured to receive sensor data from one or more sensors associated with the vehicle, determine whether a driver of the vehicle is touching a steering wheel of the vehicle based on the sensor data, upon determination that the driver of the vehicle is touching the steering wheel, perform shared lateral control of the vehicle, and upon determination that the driver of the vehicle is not touching the steering wheel, perform traded lateral control of the vehicle.

### TECHNICAL FIELD

The present specification relates to vehicle control systems, and more particularly, to a system and method for providing driver assistance features.

### BACKGROUND

Modern vehicles often have driving assistance features such as lane keeping assist and adaptive cruise control. These features must typically be activated by a driver pressing appropriate buttons on the steering wheel or an instrument panel. As such, it may be confusing to a driver how to activate certain driving assistance features or what safety features have been activated. Accordingly, a driver may think that a particular assistive driving feature has been turned on when it has not, or not know that an assistive driving feature is active. Accordingly, a need exists for an improved vehicle control system

### SUMMARY

In an embodiment, a vehicle system of a vehicle may include one or more processors configured to receive sensor data from one or more sensors associated with the vehicle, determine whether a driver of the vehicle is touching a steering wheel of the vehicle based on the sensor data, upon determination that the driver of the vehicle is touching the steering wheel, perform shared lateral control of the vehicle, and upon determination that the driver of the vehicle is not touching the steering wheel, perform traded lateral control of the vehicle.

In another embodiment, a vehicle system of a vehicle may include one or more processors configured to receive sensor data from one or more sensors associated with the vehicle, determine whether a driver of the vehicle is touching an accelerator pedal or a brake pedal based on the sensor data, upon determination that the driver of the vehicle is touching the accelerator pedal or the brake pedal, perform shared longitudinal control of the vehicle, and upon determination that the driver of the vehicle is not touching the accelerator pedal or the brake pedal, perform traded longitudinal control of the vehicle.

In another embodiment, a method may include receiving sensor data from one or more sensors associated with a vehicle, determining whether a driver of the vehicle is touching a steering wheel of the vehicle based on the sensor data, upon determination that the driver of the vehicle is touching the steering wheel, performing shared lateral control of the vehicle, and upon determination that the driver of the vehicle is not touching the steering wheel, performing traded lateral control of the vehicle.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for performing vehicle assistance, according to one or more embodiments shown and described herein;

FIG. 2 schematically depicts a vehicle system, according to one or more embodiments shown and described herein;

FIG. 3 depicts an example vehicle interior, according to one or more embodiments shown and described herein;

FIG. 4 schematically depicts memory modules of the vehicle system of FIG. 2, according to one or more embodiments shown and described herein; and

FIG. 5 depicts a flowchart of a method that may be performed by the vehicle system of FIG. 2, according to one or more embodiments shown and described herein.

### DETAILED DESCRIPTION

The embodiments disclosed herein include a method and system for providing driving assistance. When a human rides a horse, the human can exert some level of control over the horse's actions. However, the horse will not run off a cliff even if a human rider instructs it to do so. Similarly, embodiments disclosed herein provide a digital equivalent for vehicles, or an artificial intelligence (AI) horse. That is, driving assistance is provided in a vehicle to assist a driver and prevent a driver from taking certain dangerous driving actions.

Modern vehicles are able to provide a number of driving assistance features, such as lane keeping assist (LKA), lane tracing assist (LTA), adaptive cruise control (ACC), forward collision-avoidance assist (FCA), and the like. These features allow a vehicle to drive semi-autonomously, and perform certain driving functions without intervention by a human driver. In some examples, driving assistance features operate with shared control, where the human driver and the vehicle system share control of the vehicle. In shared control, some driving operations are controlled by the human driver, and some driving operations are autonomously controlled by the vehicle system. In other examples, driving assistance features operate with traded control, where either the human driver or the vehicle system controls the vehicle at any one time. In traded control systems, when a human driver is controlling the vehicle, the vehicle system is not performing any autonomous driving functions.

Driving functions typically consist of lateral control (e.g., controlling the steering wheel of a vehicle), and longitudinal control (e.g., control the accelerator and brake pedal of a vehicle). In embodiments disclosed herein, certain driving assistance features may operate in shared control while the human driver also operates the vehicle. That is, while the driver is operating the steering wheel and the accelerator or brake pedal, the vehicle system may provide a limited amount of control to assist the driver (e.g., LKA or FCA). If the driver removes their hands from the steering wheel, the vehicle system may switch to traded lateral control of the vehicle and perform lateral control without any input from the driver. Similarly, if the driver removes their foot from the accelerator and brake pedals, the vehicle may switch to traded longitudinal control of the vehicle and perform longitudinal control without any input from the driver. If the driver puts their hands back on the steering wheel or puts their foot back on the accelerator or brake pedals, the vehicle system may revert back to shared control. As such, the vehicle system may implement different driving assistance features without the need for the driver to press any buttons or otherwise turn those features on or off.

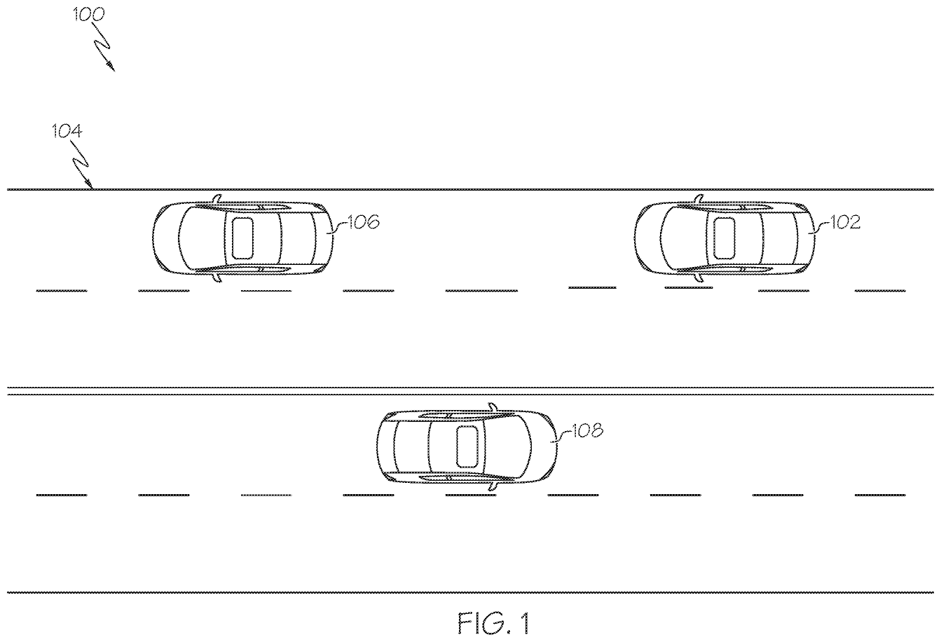

Turning now to the figures, FIG. 1 schematically depicts a system for performing driving assistance, as disclosed herein. In the example of FIG. 1, a system 100 includes an ego vehicle 102 driving along a road 104. In the example of FIG. 1, two other vehicles 106, 108 also drive along the road 104. However, in other examples, any number of other vehicles may drive along the road 104.

In the example of FIG. 1, the ego vehicle 102 may perform certain driving assistance features, as disclosed herein. That is, the ego vehicle 102 may autonomously perform certain driving functions as either shared control or traded control, as discussed in further detail below.

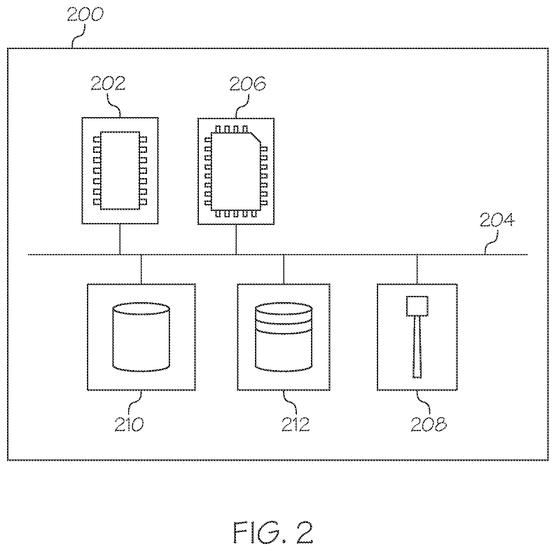

FIG. 2 depicts an example vehicle system 200 that may be included in the ego vehicle 102 of FIG. 1. In the example of FIG. 2, the vehicle system 200 includes one or more processors 202, a communication path 204, one or more memory modules 206, a satellite antenna 208, one or more vehicle sensors 210, and a data storage component 212, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the vehicle system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as Wi-Fi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Referring still to FIG. 2, the vehicle system 200 comprises a satellite antenna 208 coupled to the communication path 204 such that the communication path 204 communicatively couples the satellite antenna 208 to other modules of the vehicle system 200. The satellite antenna 208 is configured to receive signals from global positioning system satellites. Specifically, in one embodiment, the satellite antenna 208 includes one or more conductive elements that interact with electromagnetic signals transmitted by global positioning system satellites. The received signal is transformed into a data signal indicative of the location (e.g., latitude and longitude) of the satellite antenna 208, and consequently, the vehicle containing the vehicle system 200.

The vehicle system 200 comprises one or more vehicle sensors 210. Each of the one or more vehicle sensors 210 is coupled to the communication path 204 and communicatively coupled to the one or more processors 202. The one or more vehicle sensors 210 may include, but are not limited to, LIDAR sensors, RADAR sensors, optical sensors (e.g., cameras, laser sensors), proximity sensors, location sensors (e.g., GPS modules), and the like. The vehicle sensors 210 may collect data that may be used to perform autonomous driving functions.

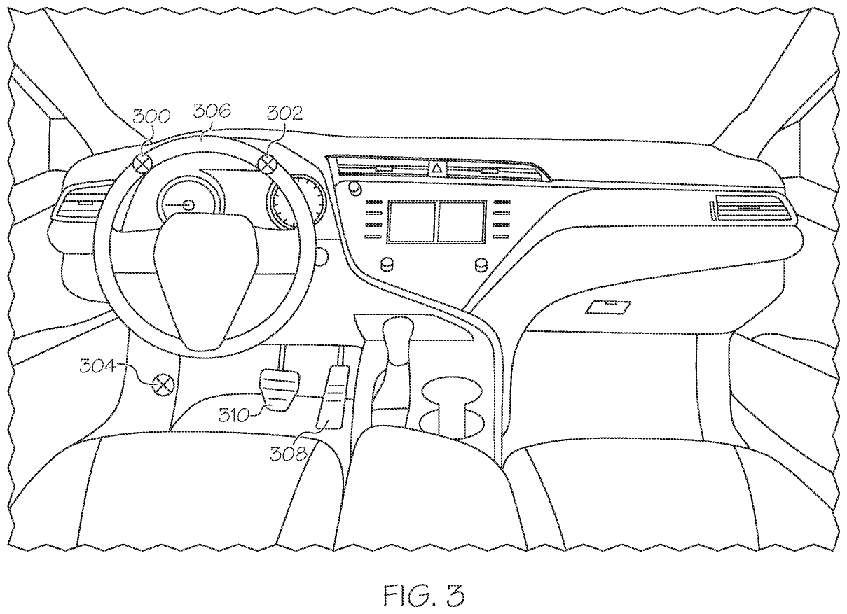

In addition, the vehicle sensors 210 may also include steering wheel sensors 300, 302 and a pedal sensor 304, as shown in FIG. 3. In embodiments, the steering wheel sensors 300, 302 may determine whether a driver's hands are on the steering wheel 306 of the ego vehicle 102, and the pedal sensor 304 may determine whether the driver's feet are on the accelerator pedal 308 or the brake pedal 310.

In one example, the steering wheel sensors 300 and 302 comprise capacitance sensors that determine whether the driver's hands are making contact with the steering wheel sensors 300, 302, and subsequently with the steering wheel 306. In other examples, the steering wheel sensors 300, 302 may comprise other types of sensors that determine whether the driver's hands are making contact with the steering wheel 306. In the illustrated example, two capacitance sensors 300, 302 are shown in positions on the steering wheel 306 that the driver is likely to touch when holding the steering wheel 306. However, in other examples, there may be any number of capacitance sensors at any positions on the steering wheel 306. In some examples, the entire steering wheel 306 may comprise a capacitance sensor to determine whether the driver is touching the steering wheel 306. In the illustrated example, the steering wheel sensors 300, 302 may be affixed to an external surface of the steering wheel 306. In other examples, the steering wheel sensors 300, 302 may be positioned inside of the steering wheel 306.

In some examples, the vehicle sensors 210 may include a torque sensor that measures a torque on the steering wheel 306. If the driver is not touching the steering wheel 306, then there will be no torque on the steering wheel 306. As such, a torque sensor may determine that the driver is touching the steering wheel 306 when the torque on the steering wheel 306 is greater than a predetermined amount. In some examples, the vehicle sensors 210 may include a camera that captures an image of the steering wheel 306 and performs image analysis to determine whether the driver is touching the steering wheel 306.

Although embodiments described herein refer to the steering wheel 306 and steering wheel sensors 300 and 302, in other examples, the vehicle system 200 may include other devices for performing lateral control of the ego vehicle 102. For example, the vehicle system 200 may include a joystick or other lateral control element to perform lateral control of the ego vehicle 102. In these examples, the steering wheel sensors 300, 302 may be replaced with sensors that determine whether the driver of the ego vehicle 102 is touching the lateral control element of the vehicle system 200.

The pedal sensor 304 may determine whether the driver's feet are touching the accelerator pedal 308 or the brake pedal 310. In the illustrated example, the pedal sensor 304 comprises a camera affixed to or embedded in a driver's side door or side panel of the ego vehicle 102, which captures images of the accelerator pedal 308 and the brake pedal 310. In the illustrated example, the pedal sensor 304 performs image analysis to determine whether the driver's feet are touching the accelerator pedal 308 or the brake pedal 310 based on such captured images. In other examples, other types of sensors may be used to determine whether the driver's feet are touching the accelerator pedal 308 or the brake pedal 310. For example, the pedal sensor 304 may comprise a contact sensor or proximity sensor affixed to or embedded in the accelerator pedal 308 and/or the brake pedal 310.

Although embodiments described herein refer to the accelerator pedal 308, the brake pedal 310, and the pedal sensor 304, in other examples, the vehicle system 200 may include other devices for performing longitudinal control of the vehicle. For example, the vehicle system 200 may include a throttle controller or longitudinal control element. In these examples, the pedal sensor 304 may be replaced with a sensor that determines whether the driver of the ego vehicle 102 is touching the longitudinal control element of the vehicle system 200.

Still referring to FIG. 2, the vehicle system 200 comprises a data storage component 212. The data storage component 212 may store data used by various components of the vehicle system 200. In addition, the data storage component 212 may store data collected by the vehicle sensors 210.

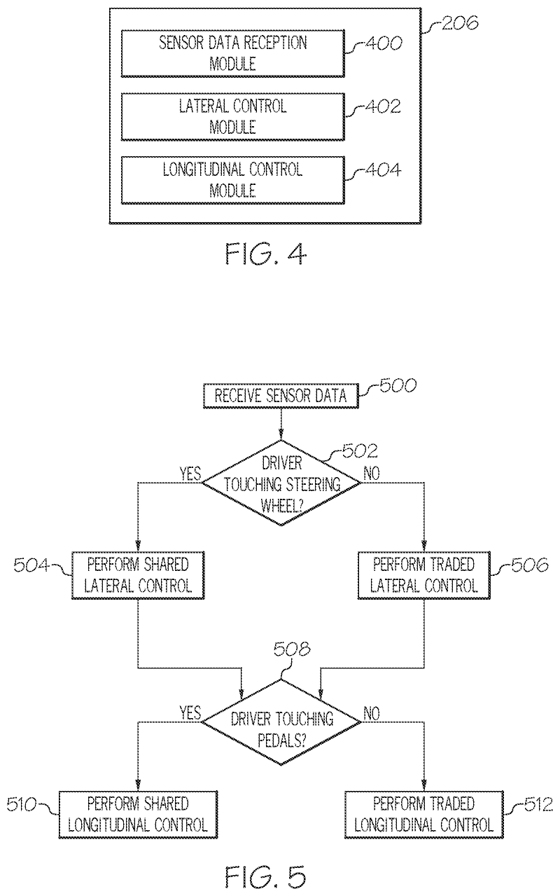

Now referring to FIG. 4, the memory modules 206 of the vehicle system 200 are schematically shown. The one or more memory modules 206 include a sensor data reception module 400, a lateral control module 402, and a longitudinal control module 404. Each of the sensor data reception module 400, the lateral control module 402, and the longitudinal control module 404 may be a program module in the form of operating systems, application program modules, and other program modules stored in the one or more memory modules 206. In some embodiments, the program module may be stored in a remote storage device that may communicate with the vehicle system 200. Such a program module may include, but is not limited to, routines, subroutines, programs, objects, components, data structures and the like for performing specific tasks or executing specific data types as will be described below.

The sensor data reception module 400 may receive data from the vehicle sensors 210. In particular, the sensor data reception module 400 may receive data from the steering wheel sensors 300, 302 and from the pedal sensor 304. Based on the data received from the steering wheel sensors 300, 302 and the pedal sensor 304, the sensor data reception module 400 may determine whether a driver of the ego vehicle 102 is touching the steering wheel 306 and whether the driver is touching the accelerator pedal 308 or the brake pedal 310.

In embodiments, the sensor data reception module 400 may continually receive data from the steering wheel sensors 300 302, and from the pedal sensor 304 (e.g., data may be received every second). As such, the sensor data reception module 400 may determine whether the driver of the ego vehicle 102 is touching the steering wheel 306 or the accelerator pedal 308 or the brake pedal 310 at a plurality of time steps. The lateral control module 402 and the longitudinal control module 404 may perform different types of vehicle control depending on whether the driver is touching the steering wheel 306 and whether the driver is touching the accelerator pedal 308 or the brake pedal 310, as discussed in further detail below.

The lateral control module 402 may perform lateral control of the ego vehicle 102, as disclosed herein. As used herein, lateral control refers to controlling steering of the ego vehicle 102, thereby controlling the lateral direction of the ego vehicle 102. In embodiments, the lateral control module 402 may perform shared lateral control of the ego vehicle 102 while the driver is touching the steering wheel 306, and may perform traded lateral control of the ego vehicle 102 while the driver is not touching the steering wheel 306, as discussed in further detail below.

In the illustrated example, when the driver of the ego vehicle 102 is touching the steering wheel 306, the lateral control module 402 may perform shared lateral control of the ego vehicle 102. That is, the vehicle system 200 may perform a limited amount of lateral control while the driver of the ego vehicle 102 also performs lateral control using the steering wheel 306. In particular, while performing shared lateral control, the driver is expected to exert primary control of steering the ego vehicle 102 while the lateral control module 402 provides supplemental or supportive lateral control. For example, while performing shared lateral control, the lateral control module 402 may perform LKA. That is, while performing shared lateral control, the vehicle sensors 210 may monitor the lane lines of the lane in which the ego vehicle 102 is driving, and if the ego vehicle 102 drifts too close to the lane lines or starts to veer into another lane, the lateral control module 402 may nudge the vehicle back towards the center of the lane to prevent the ego vehicle 102 from unintentionally veering into the another lane. In another example, while performing shared lateral control, the vehicle sensors 210 may detect that the lane the ego vehicle 102 is driving in approaches a curve or a turn, and if the driver does not turn the steering wheel a sufficient amount to navigate the curve or turn, the lateral control module 402 may turn the steering wheel an additional amount to ensure that the ego vehicle 102 properly navigates the curve or turn.

However, while the lateral control module 402 performs shared lateral control, there may be limits to the amount of lateral control exerted by the lateral control module 402, as the driver is expected to use the steering wheel 306 to perform a certain amount of lateral control such that lateral control is shared between the driver and the lateral control module 402. In one example, while performing shared lateral control, the lateral control module 402 may be limited to creating a maximum amount of centrifugal force (e.g., no more than 0.3 g). While performing traded control, the lateral control module 402 may perform lateral control without such limits.

When the driver lets go of the steering wheel 306 and no longer performs lateral control, the lateral control module 402 may perform traded lateral control. That is, when the driver is not controlling the steering wheel, the lateral control module 402 may perform full lateral control of the vehicle without any limits, as discussed above, until the driver resumes use of the steering wheel 306, and the lateral control module 402 goes back to shared lateral control. In some examples, the lateral control module 402 may begin to perform traded lateral control as soon as the driver lets go of the steering wheel 306. In other examples, the lateral control module 402 may begin to perform traded lateral control after the driver has let go of the steering wheel 306 for more than a threshold amount of time (e.g., more than two seconds).

When performing traded lateral control, the vehicle sensors 210 may gather sensor data about the state of the ego vehicle 102 and the surrounding environment, and the lateral control module 402 may autonomously control the steering of the ego vehicle 102 using the sensor data. In some examples, after the driver touches the steering wheel 306, the lateral control module 402 may go back to shared lateral control. In other examples, the lateral control module 402 may only go back to shared lateral control when the driver touches the steering wheel 306 for more than a threshold amount of time (e.g., more than two seconds).

While the lateral control module 402 is controlling steering of the ego vehicle 102 in a traded control mode, the human driver may still perform longitudinal control of the ego vehicle 102 by using the accelerator pedal 308 and/or the brake pedal 310. That is, the human driver may control braking and acceleration of the ego vehicle 102 while the lateral control module 402 autonomously controls the steering. However, it is also possible for the driver to relinquish both lateral control and longitudinal control of the ego vehicle 102 to the vehicle system 200, as discussed below.

The longitudinal control module 404 may perform longitudinal control of the ego vehicle 102, as disclosed herein. As used herein, longitudinal control refers to controlling braking and acceleration of the ego vehicle 102, thereby controlling the longitudinal speed of the ego vehicle 102. In embodiments, the longitudinal control module 404 may perform shared longitudinal control of the ego vehicle 102 while the driver is touching the accelerator pedal 308 or the brake pedal 310, and may perform traded longitudinal control of the ego vehicle 102 while the driver is not touching the accelerator pedal 308 or the brake pedal 310, as discussed in further detail below.

In the illustrated example, when the driver of the ego vehicle 102 is touching the accelerator pedal 308 or the brake pedal 310, the longitudinal control module 404 may perform shared longitudinal control of the ego vehicle 102. That is, the vehicle system 200 may perform a limited amount of longitudinal control while the driver of the ego vehicle 102 also performs longitudinal control using the accelerator pedal 308 or the brake pedal 310. In particular, while performing shared longitudinal control, the driver is expected to exert primary control of the speed of the ego vehicle 102 while the longitudinal control module 404 provides supplemental or supportive longitudinal control. For example, while performing shared longitudinal control, the longitudinal control module 404 may perform FCA. That is, while performing shared longitudinal control, the vehicle sensors 210 may monitor vehicles in front of the ego vehicle 102, and the longitudinal control module 404 may autonomously brake the ego vehicle 102 if the ego vehicle gets too close to another vehicle in order to prevent a forward collision. In other examples, the longitudinal control module 404 may perform other types of shared longitudinal control.

When the driver takes their foot off the accelerator pedal 308 and the brake pedal 310 and no longer performs longitudinal control, the longitudinal control module 404 may perform traded longitudinal control. That is, when the driver is not controlling the speed of the ego vehicle 102, the longitudinal control module 404 may perform full longitudinal control of the vehicle until the driver again steps on the accelerator pedal 308 or the brake pedal 310, and the longitudinal control module 404 goes back to shared longitudinal control. In some examples, the longitudinal control module 404 may begin to perform traded longitudinal control as soon as the driver takes their foot off the accelerator pedal 308 or the brake pedal 310. In other examples, the longitudinal control module 404 may begin to perform traded longitudinal control after the driver has taken their foot off of the accelerator pedal 308 and the brake pedal 310 for more than a threshold amount of time (e.g., more than two seconds).

In one example, while performing traded longitudinal control, the longitudinal control module 404 may perform cruise control, wherein the speed of the ego vehicle 102 is maintained at a constant rate. In another example, while performing traded longitudinal control, the longitudinal control module 404 may perform adaptive cruise control, wherein the speed of the ego vehicle 102 is maintained at a maximum rate, and a minimum distance is maintained between the ego vehicle 102 and a forward vehicle (e.g., the vehicle 106 of FIG. 1). In other examples, while performing traded longitudinal control, the longitudinal control module 404 may perform other types of longitudinal control (e.g., slowing down and/or stopping for traffic signs and traffic lights, adjusting to different speed limits, slowing down to navigate turns, and the like).

When performing traded longitudinal control, the vehicle sensors 210 may gather sensor data about the state of the ego vehicle 102 and the surrounding environment, and the longitudinal control module 404 may autonomously control acceleration and braking of the ego vehicle 102 using the sensor data. In embodiments, after the driver touches the accelerator pedal 308 or the brake pedal 310, the longitudinal control module 404 may go back to shared longitudinal control.

While the longitudinal control module 404 is controlling the speed of the ego vehicle 102 in a traded control mode, the human driver may still perform lateral control of the ego vehicle 102 by using the steering wheel 306. That is, the human driver may control steering of the ego vehicle 102 while the longitudinal control module 404 autonomously controls the speed. However, it is also possible for the driver to relinquish both longitudinal control and lateral control of the ego vehicle 102 to the vehicle system 200.

FIG. 5 depicts a flowchart of an example method that may be performed by the vehicle system 200 of FIG. 2. At step 500, the sensor data reception module 400 receives sensor data from the vehicle sensors 210. In particular, the sensor data reception module 400 may receive data from the steering wheel sensors 300, 302 and from the pedal sensor 304.

At step 502, the sensor data reception module 400 determines whether the driver of the ego vehicle 102 is touching the steering wheel 306 based on the received sensor data. In some examples, if the driver is not touching the steering wheel 306, the sensor data reception module 400 may determine whether the driver has not touched the steering wheel 306 for greater than a threshold amount of time. If the sensor data reception module 400 determines that the driver is touching the steering wheel 306 (Yes at step 502), then control passes to step 504. If the sensor data reception module 400 determines that the driver is not touching the steering wheel 306 (No at step 502), then control passes to step 506.

At step 504, when the driver of the ego vehicle 102 is touching the steering wheel 306, the lateral control module 402 performs shared lateral control of the ego vehicle 102. That is, the lateral control module 402 and the driver of the ego vehicle 102 both perform lateral control of the ego vehicle 102. In some examples, when performing shared lateral control, the lateral control module 402 may perform lateral control such that a predetermined amount of centrifugal force on the ego vehicle 102 is not exceeded.

At step 506, when the driver of the ego vehicle 102 has not touched the steering wheel 306 for greater than a predetermined amount of time, the lateral control module 402 performs traded lateral control of the ego vehicle 102. That is, the lateral control module 402 performs lateral control of the ego vehicle 102 without any input by the driver. In some examples, when performing traded lateral control, the lateral control module 402 may perform lateral control without any limits on the amount of centrifugal force on the ego vehicle 102. When the driver again touches the steering wheel 306, the lateral control module 402 may go back to performing shared lateral control.

At step 508, the sensor data reception module 400 determines whether the driver of the ego vehicle 102 is touching the accelerator pedal 308 or the brake pedal 310 based on the received sensor data. If the sensor data reception module 400 determines that the driver of the ego vehicle 102 is touching the accelerator pedal 308 or the brake pedal 310 (Yes at step 508), then control passes to step 510. If the sensor data reception module 400 determines that the driver of the ego vehicle 102 is not touching the accelerator pedal 308 or the brake pedal 310 (No at step 508), then control passes to step 512.

At step 510, when the driver of the ego vehicle 102 is touching the accelerator pedal 308 or the brake pedal 310, the longitudinal control module 404 performs shared longitudinal control of the ego vehicle 102. That is the longitudinal control module 404 and the driver of the ego vehicle 102 both perform longitudinal control of the ego vehicle 102.

At step 512, when the driver of the ego vehicle 102 is not touching the accelerator pedal 308 or the brake pedal 310, the longitudinal control module 404 performs traded longitudinal control of the ego vehicle 102. That is, the longitudinal control module 404 performs longitudinal control of the ego vehicle 102 without any input by the driver. When the driver again touches the accelerator pedal 308 or the brake pedal 310, the longitudinal control module 404 may go back to performing shared longitudinal control.

It should now be understood that embodiments described herein are directed to a vehicle system for performing driving assistance. As a human driver drives a vehicle, a vehicle system may perform shared control of the vehicle, thereby assisting the driver in driving operations. For example, the vehicle system may perform shared lateral control (e.g., LKA) and shared longitudinal control (e.g., FCA). The vehicle system performing certain driving assistance functions while the driver drives the vehicle may improve the overall driving performance of the vehicle.

If the driver of the vehicle removes their hands from the steering wheel, the vehicle system may automatically begin to perform traded lateral control of the vehicle until the driver touches the steering wheel again. Furthermore, if the driver removes their feet from the pedals, the vehicle system may automatically begin to perform traded longitudinal control of the vehicle until the driver touches the pedals again. This may allow the driver to easily activate or deactivate autonomous lateral control and autonomous longitudinal control of the vehicle without the need to push any buttons. Furthermore, the driver may continue to perform lateral control while the vehicle system autonomously performs longitudinal control or the driver may perform longitudinal control while the vehicle system performs lateral control. As such, the driving experience of the driver and the overall driving performance of the vehicle may be improved.

In some examples, the vehicle system may prevent the driver from taking certain detrimental actions. This is analogous to a human riding a horse, and instructing the horse to jump off a cliff. The horse will refuse to jump off the cliff since it knows that this is dangerous. Similarly, the vehicle system may prevent the driver from taking certain actions when driving manually.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle system of a vehicle comprising one or more processors configured to:
receive sensor data from one or more sensors associated with the vehicle;
determine whether a driver of the vehicle is touching a steering wheel of the vehicle based on the sensor data;
upon determination that the driver of the vehicle is touching the steering wheel, perform shared lateral control of the vehicle; and
upon determination that the driver of the vehicle is not touching the steering wheel, perform traded lateral control of the vehicle.

2. The vehicle system of claim 1, wherein the one or more sensors comprise one or more capacitance sensors that detect when the driver of the vehicle is touching the steering wheel.

3. The vehicle system of claim 1, wherein the one or more sensors measure a torque associated with the steering wheel.

4. The vehicle system of claim 1, wherein the one or more processors are further configured to:
perform shared lateral control of the vehicle by performing lane keeping assistance; and
perform traded lateral control of the vehicle by performing lane tracing assistance.

5. The vehicle system of claim 1, wherein the one or more processors are further configured to:
perform shared lateral control of the vehicle by performing lateral control such that a centrifugal force on the vehicle remains below a predetermined amount; and
perform traded lateral control of the vehicle by performing lateral control without a limit to the centrifugal force on the vehicle.

6. The vehicle system of claim 1, wherein the one or more processors are further configured to:
determine, based on the sensor data, whether the driver has not touched the steering wheel for more than a predetermined amount of time; and
upon determination that the driver has not touched the steering wheel for more than the predetermined amount of time, perform traded lateral control of the vehicle.

7. The vehicle system of claim 1, wherein the one or more processors are further configured to:
while performing traded lateral control, determine whether the driver touches the steering wheel; and
upon determination that the driver touches the steering wheel, perform shared lateral control.

8. A vehicle system of a vehicle comprising one or more processors configured to:
receive sensor data from one or more sensors associated with the vehicle;
determine whether a driver of the vehicle is touching an accelerator pedal or a brake pedal based on the sensor data;
upon determination that the driver of the vehicle is touching the accelerator pedal or the brake pedal, perform shared longitudinal control of the vehicle; and
upon determination that the driver of the vehicle is not touching the accelerator pedal or the brake pedal, perform traded longitudinal control of the vehicle.

9. The vehicle system of claim 8, wherein the one or more sensors comprise a camera that captures an image of the accelerator pedal and the brake pedal.

10. The vehicle system of claim 8, wherein the one or more processors are further configured to:
perform shared longitudinal control of the vehicle by performing forward collision avoidance assistance; and
perform traded longitudinal control of the vehicle by performing adaptive cruise control.

11. The vehicle system of claim 8, wherein the one or more processors are further configured to:
while performing traded longitudinal control, determine whether the driver touches the accelerator pedal or the brake pedal; and
upon determination that the driver touches the accelerator pedal or the brake pedal, perform shared longitudinal control.

12. A method comprising:
receiving sensor data from one or more sensors associated with a vehicle;
determining whether a driver of the vehicle is touching a steering wheel of the vehicle based on the sensor data;
upon determination that the driver of the vehicle is touching the steering wheel, performing shared lateral control of the vehicle; and
upon determination that the driver of the vehicle is not touching the steering wheel, performing traded lateral control of the vehicle.

13. The method of claim 12, wherein the one or more sensors comprise one or more capacitance sensors that detect when the driver of the vehicle is touching the steering wheel.

14. The method of claim 12, wherein the one or more sensors measure a torque associated with the steering wheel.

15. The method of claim 12, further comprising:
performing shared lateral control of the vehicle by performing lane keeping assistance; and
performing traded lateral control of the vehicle by performing lane tracing assistance.

16. The method of claim 12, further comprising:
performing shared lateral control of the vehicle by performing lateral control such that a centrifugal force on the vehicle remains below a predetermined amount; and
performing traded lateral control of the vehicle by performing lateral control without a limit to the centrifugal force on the vehicle.

17. The method of claim 12, further comprising:
determining, based on the sensor data, whether the driver has not touched the steering wheel for more than a predetermined amount of time; and
upon determination that the driver has not touched the steering wheel for more than the predetermined amount of time, performing traded lateral control of the vehicle.

18. The method of claim 12, further comprising:
determining whether the driver of the vehicle is touching an accelerator pedal or a brake pedal based on the sensor data;
upon determination that the driver of the vehicle is touching the accelerator pedal or the brake pedal, performing shared longitudinal control of the vehicle; and
upon determination that the driver of the vehicle is not touching the accelerator pedal or the brake pedal, performing traded longitudinal control of the vehicle.

19. The method of claim 18, wherein the one or more sensors comprise a camera that captures an image of the accelerator pedal and the brake pedal.

20. The method of claim 18, further comprising:
performing shared longitudinal control of the vehicle by performing forward collision avoidance assistance; and
performing traded longitudinal control of the vehicle by performing adaptive cruise control.
